(19) United States
(12) Patent Application Publication
(10) Pub. No.: US 2020/0104404 A1
(43) Pub. Date: Apr. 2, 2020

(54) SEAMLESS MIGRATION OF DISTRIBUTED SYSTEMS

(71) Applicant: Microsoft Technology Licensing, LLC, Redmond, WA (US)

(72) Inventors: Saung Li, Sunnyvale, CA (US); Lanhui Long, Sunnyvale, CA (US); Haochen Wei, Sunnyvale, CA (US); Yiheng Wang, Sunnyvale, CA (US); Hao Liu, Mountain View, CA (US); Sourav Maji, Sunnyvale, CA (US); Cindy Chen, Sunnyvale, CA (US)

(21) Appl. No.: 16/147,737

(22) Filed: Sep. 29, 2018

(51) Int. Cl. G06F 17/30; H04L 29/08; G06F 9/54

(52) U.S. Cl. CPC G06F 17/30575; G06F 9/547; G06F 17/30377; H04L 67/32

(57) ABSTRACT

Techniques for migrating clients from one technology stack to another are provided. In one technique, while a legacy service is hosted that is actively serving requests from multiple clients, a new service is initiated and one or more clients send requests to the new service. The legacy service reads data from and writes data to a legacy database in response to the requests. The new service forwards, to the legacy service, a first set of client requests that were directed to the new service. A new database is synchronized with the legacy database. After synchronization, the legacy service forwards, to the new service, a second set of client requests, which the new service processes.

### TECHNICAL FIELD

The present disclosure relates to migration of distributed systems and, more particularly to, migrating clients from one technology stack to another with little to no downtime.

### BACKGROUND

At times, enterprises desire to update the functionality of their existing services, such as changing the business logic of the services or even changing the inputs and/or outputs of the services. In order for clients of those services to migrate to the new versions of those services, the clients must disconnect from the services and reconnect to the new versions. For relatively small enterprises with simple system architectures, such a “migration” might be trivial in terms of time and technical know-how. However, for large enterprises where there are potentially many clients (e.g., both internal and external) that rely on the services that are being upgraded or taken offline, migration can be much more disruptive and may take a significant amount of time to accomplish. For example, some services may process 140 thousand queries per second (qps). Current approaches for migrating clients to different services or new versions of existing services are neither smooth nor easy.

When completely rewriting a technical stack serving traffic to hundreds of clients, such a process involves spinning up a new, independent stack with all of the data ported over from the legacy stack. Client traffic needs to shift from one stack to another. Several approaches are available in this scenario depending on the complexity of the architectures and operational requirements. In one approach, dual writes may be implemented, but are error prone if the second write fails, which leads to databases with inconsistent data. This approach also requires a separate methodology to do a one-time bulk upload of data into the new database. In simple scenarios where the service has few clients and low traffic, a one-time port of data along with an all-or-nothing shift in traffic to the new stack may suffice. However, rollback is not an option.

These options are not sufficient in scenarios where there are a large number of clients and significant client traffic, and where errors should be mitigated and rollbacks are an option during ramping. Indeed, actually migrating of clients requires a significant human effort and time involving rewriting client code. In a typical migration involving rewriting client code, it can take up to two weeks to migrate each online client, three weeks to migrate each nearline client, and one week to migrate each offline client. Thus, for example, if there are 70 online clients, 15 nearline clients, and 140 offline clients, then a typical approach to client migration would take approximately 325 man-weeks to complete.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1A is a block diagram of an example legacy system architecture that supports calls from online clients, offline clients, and nearline clients;

FIG. 1B is a block diagram of an example new system architecture that comprises fewer and simpler components than a legacy system architecture, in an embodiment;

FIG. 2A is a block diagram that depicts a first stage of client migration, in an embodiment;

FIG. 2B is a block diagram that depicts a second stage of client migration, in an embodiment;

FIG. 2C is a block diagram that depicts a third stage of client migration where online client requests received by a legacy service may be forwarded to a new service, in an embodiment;

FIG. 2D is a block diagram that depicts a fourth stage of migration where online client requests are all directed to the new service, in an embodiment;

FIG. 3 is a flow diagram that depicts a process for migrating online clients to a new technology stack, in an embodiment;

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for migrating to a new technology stack are provided. The migration is performed in such a way to not require current clients to online services or data sources to migrate explicitly or to modify their business logic in order to handle a new data format. In one approach, a new service that supports a set of APIs is initiated while a legacy service that supports a different set of APIs is processing client requests. API calls to the new service are translated and processed by the legacy service. A new database is synchronized with a legacy database with which the legacy service interacts (whether directly or indirectly). The legacy service can then begin forwarding client requests to the new service, which may begin to implement the same set of APIs as the legacy service. Once instances of the new service host the same set of APIs as the legacy service, the legacy service may be decommissioned.

Embodiments improve computer technology by making client migrations to new services and/or new data sources virtually seamless, requiring zero change in client logic.

One embodiment involving traffic routing completely eliminates the dependency on migrating online clients for a legacy stack to be decommissioned, thereby expediting the reduction of technical debt and improving developer velocity. Online clients can continue to make the exact same calls to legacy APIs and do not need to be involved at all since traffic is redirected to the new technology stack, which saves time and resources from having to coordinate client migrations. Ramping is controlled by the service owners, which means that the migration timeline and changes in traffic are fully deterministic.

One embodiment involving a two-way database sync results in (1) both technical stacks being able to serve write traffic concurrently, (2) errors and failures being auto-corrected, and (3) the ability to roll back traffic migrations.

One embodiment involving offline client migrations involves only changing a path from which offline clients are loading data without modifying their existing business logic, which significantly expedites data source migrations and enables future backwards incompatible schema evolution if required. Also, because offline client migrations are de-coupled from the implementation of new data sources to which the clients need to migrate, legacy data sources may be decommissioned sooner, cutting down cost. Furthermore, changing of source-of-truths under derived data sources is controlled by service owners; therefore, the migration timeline and changes in traffic are fully deterministic.

One embodiment involve nearline client migrations involves creating a view of streams with the exact same schema as existing streams. In this way, nearline clients only change the path from which they are consuming and do not need to modify any of their existing business logic. This significantly expedites data source migrations and enables future backwards incompatible schema evolution if required. Also, because nearline client migrations are de-coupled from the implementation of new data sources to which clients need to migrate, legacy data sources may be decommissioned sooner, reducing cost. Furthermore, ramping of source-of-truths under views is controlled by the service owners; therefore, the migration timeline and changes in traffic are fully deterministic.

One embodiment involving multi-data source validations results in validating data consistency between different sources across their entire data sets. Such embodiment may be performed offline so that online services are not impacted by increased latencies, call counts, and errors.

### Old System Overview

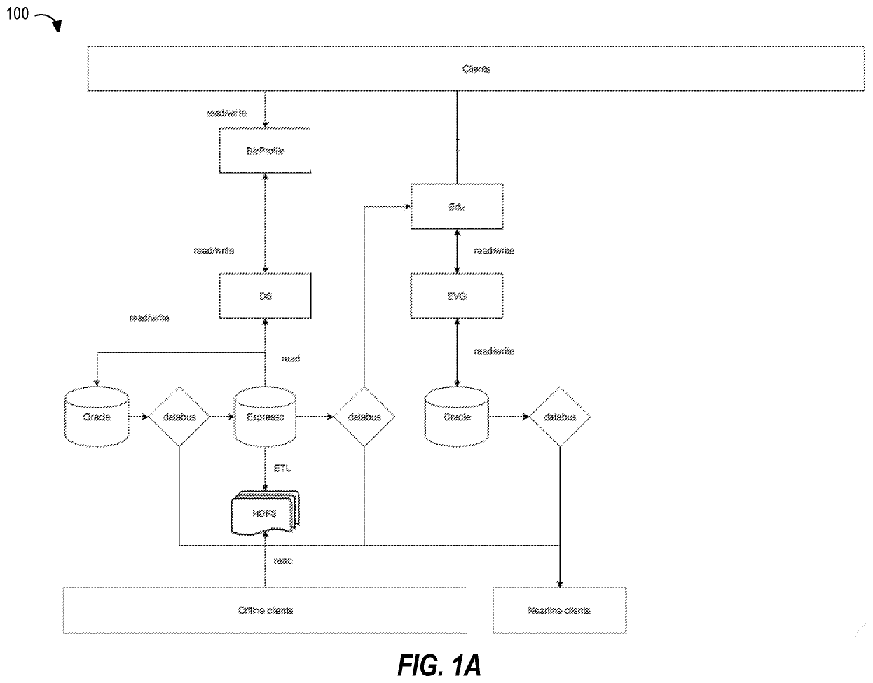

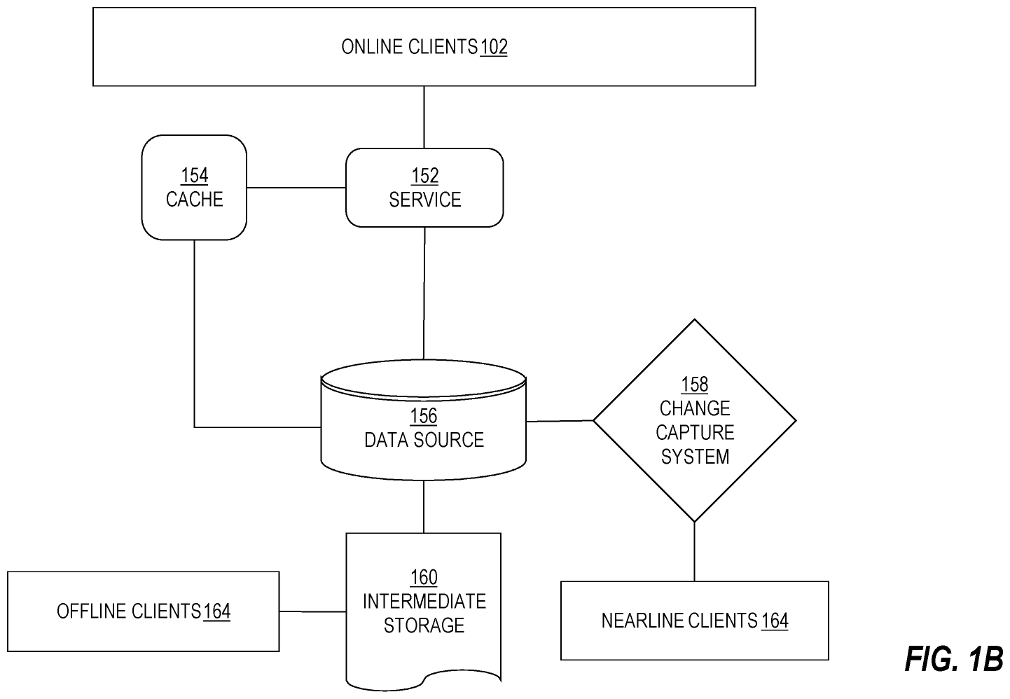

FIG. 1A is a block diagram of an example system architecture 100 that supports calls from online clients 102, offline clients 104, and nearline clients 106. Some online clients may be internal clients (or clients operated by the same entity that provides system architecture 100) while other online clients may be external clients (or clients operated by third party entities). Offline clients 104 and nearline clients 106 may be internal clients only.

System architecture 100 may comprise multiple unnecessary components, redundant data, and/or redundant processes. For example, company service 110 and education service 112 may host the same set of APIs, databases 130 and 134 may contain the same data (though in different form) and databases 130 and 140 may contain similar data. For example, the content of database 140 may be a subset of the content of database 130.

### New System Overview

FIG. 1B is a block diagram of an example new system architecture 150 that comprises fewer and simpler components than system architecture 100, in an embodiment. The following are examples of system changes:
instead of two similar services 110 and 112, system architecture 150 includes a single service 152 that replaces services 110 and 112;
instead of multiple caches, system architecture 150 includes a single cache 154;
instead of four data sources, system architecture 150 includes a single data source 156;
instead of multiple change capture systems, system architecture 150 includes a single data change capture system 158.

Migrating online clients from old services to new services and migrating offline and nearline clients from old data sources to new data sources is not a trivial matter, especially when there are many clients concurrently transmitting read and/or write requests to the services/data sources.

An example of cache 154 is one provided by Couchbase.

Examples of data sources include relational databases, object-relational databases, key-value stores, and noSQL databases, an example of which is Espresso, a distributed, fault-tolerant noSQL database.

A change capture system captures changes that are made to a data source by generating events that describe the changes and transmits the changes to downstream consumers that subscribe to certain types of events. An example of a change capture system is Databus, which has the following features: isolation between sources and consumers; guaranteed in order and at least once delivery with high availability; consumption from an arbitrary time point in the change stream including full bootstrap capability of the entire data; partitioned consumption; and source consistency preservation. Databus is able to achieve high throughput and low replication latencies. Change capture systems, such as Databus, may be used for multiple purposes, such as delivering events to downstream consumers or nearline clients (such as clients responsible for updating search indexes and/or graph indexes and clients responsible for standardization) and multi-data center replication, where each locally originated write is forwarded on to one or more remote data centers.

### Hosting a New Service

In order to transform old system architecture 100 to something resembling new system architecture 150, multiple stages of traffic migration are implemented. In one stage, a new service is added to the architecture. The new service hosts a new set of APIs that is different than the set of APIs hosted by an old service. The new set of APIs may be based on a new data model that is being implemented for the underlying data. For example, previously, companies and schools were modeled differently, even though they share much of the same type of data, such as size and location. A new data model may be implemented for organizations that subsumes companies and schools and, optionally, other types of organizations that are not normally categorized as either a company or a school, such as a charitable organization or a church.

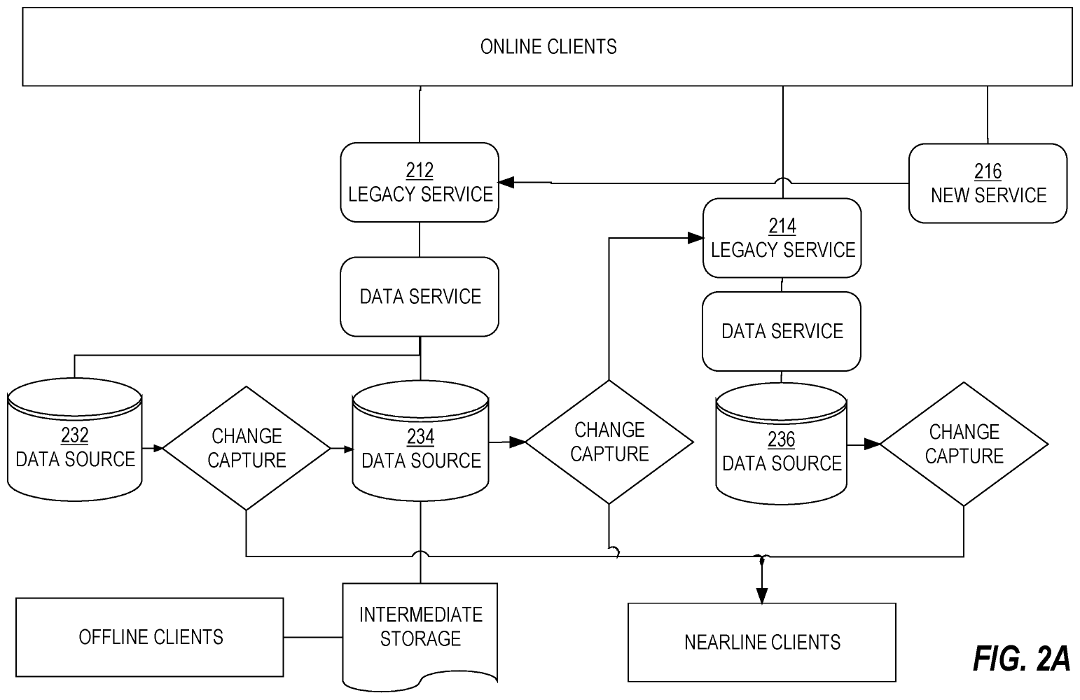

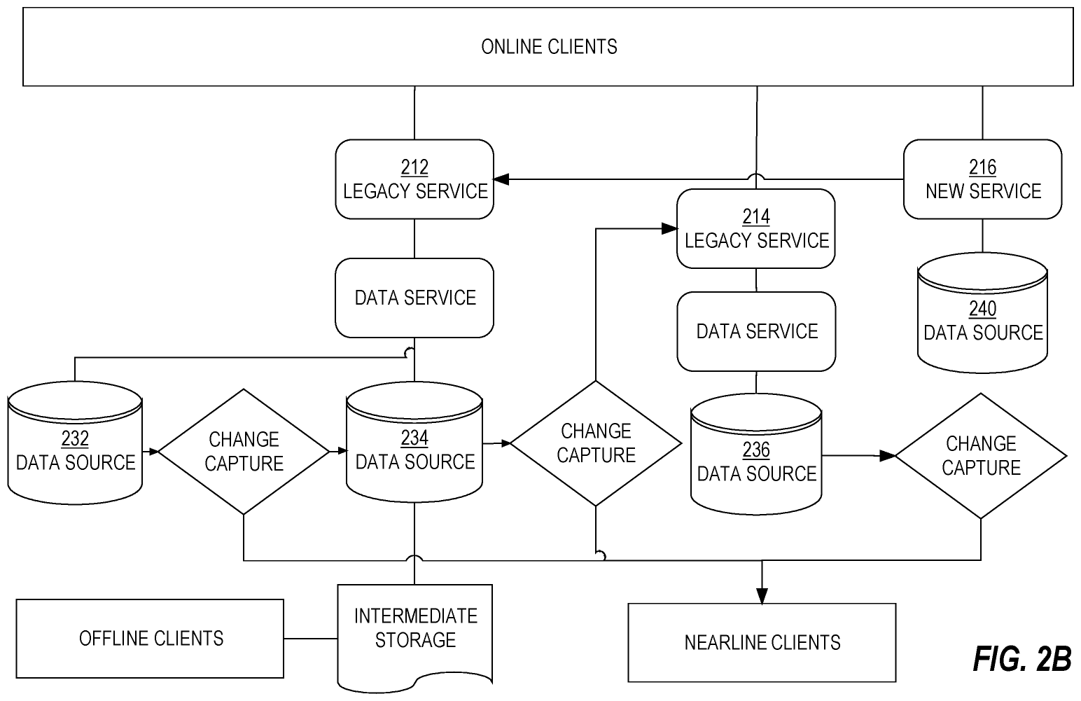

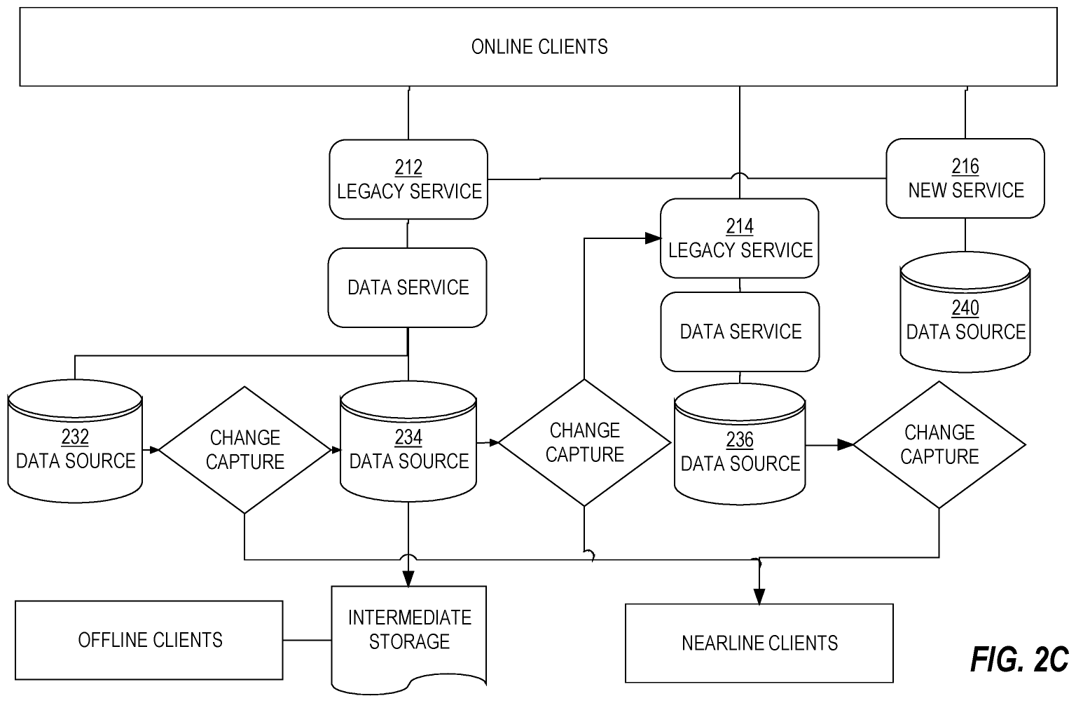

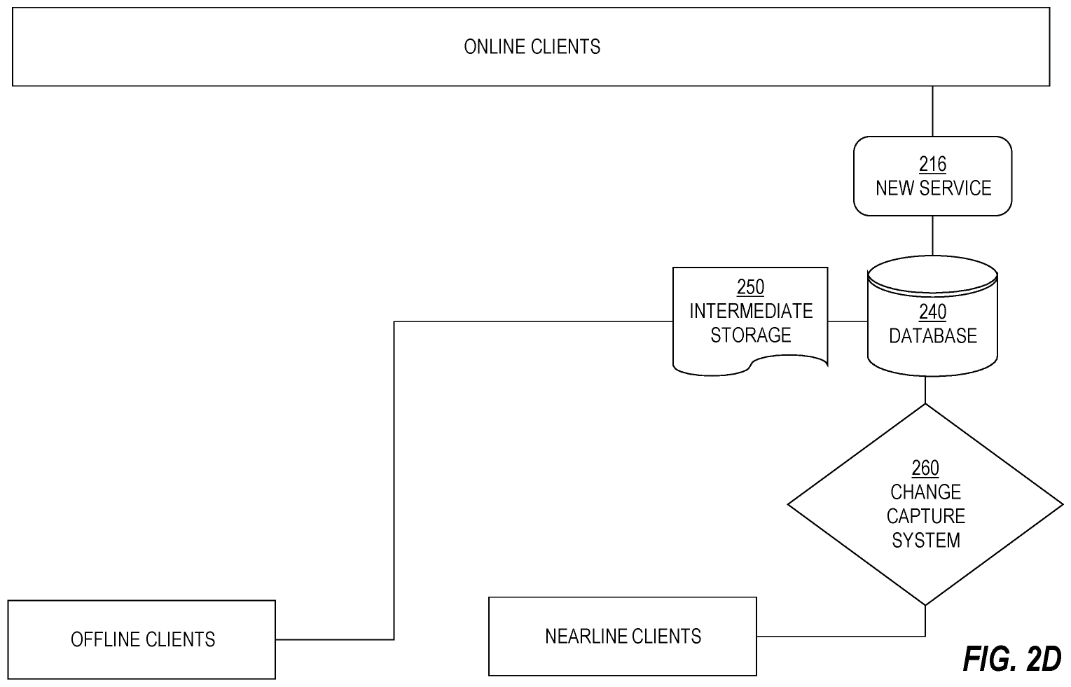

FIG. 2A is a block diagram that depicts a first stage of client migration, in an embodiment. System architecture 200 is a simplified version of system architecture 100. Also, system architecture 200 includes new service 216.

New external online clients are exposed only to the new set of APIs of new service 216. Some of the APIs of new service 216 may be the same as those supported by old services 212 and 214. When a call to new service 216 occurs, that call is directed to and handled (at least initially) by new service 216.

Because there is no backend database upon which new service 216 relies, in response to receiving a client request from an online client, new service 216 generates a second request to an API supported by old service 212 and transmits the request to old service 212. The format of the data included in the client request may also be altered for the second request to conform to an older (or currently supported) data model, in the scenario where a new data model is being rolled out. For example, if the client request is a write request, then data within the client request is modified to conform to the new data model and the modified data is included in the second request.

If a client request from an online client to new service 216 is a read request, then new service 216 generates a second request based on the read request and transmits the second request to old service 212. Then, data in a response from old service 212 is modified (e.g., re-formatted) (in the case of a different data model) and the response is modified to conform to a format that the online client is expecting.

### Database Synchronization

Before online client requests to old services 212-214 can be handled by new service 216, a new database that is synchronized with one of the legacy databases (e.g., database 234) needs to be added to system architecture 200 and communicatively coupled to new service 216. FIG. 2B is a block diagram that depicts a second stage of client migration, in an embodiment. System architecture 200 includes a new database 240.

Synchronizing two databases may be performed in one of multiple ways. For example, a snapshot of database 234 is taken, an event is generated for each record indicated in the snapshot, and the event is transmitted to new database 240. Any updates to legacy database 234 that occur after the snapshot is taken are stored (e.g., persistently) and transmitted to new database 240. Example updates include adding a new record, changing an existing record, and deleting an existing record. The transmission of updates may be implemented using a first stream processor (not depicted) associated with legacy database 234. For each update to legacy database 234, the first stream processor causes an event indicating the update to be applied to new database 240. The event may indicate a type of update (e.g., add, change, delete), a record, row, or object identifier (ID), and, for updates that involve changing an existing record, a field name that was changed, the new field value, and, optionally, the old field value. In the scenario where a new data model is implemented in the new stack, the first stream processor converts data from an old data schema to a new data schema. A data schema is a structure for organizing and classifying data in a database. A data schema defines both the data contents and relationships.

The first stream processor may include retry logic that automatically retries causing a change to be applied to new database 240 in case a previous or original attempt failed. An advantage of this approach is that retry logic does not have to be built into (or implemented by) any of services 212-216.

Since the legacy stack is complicated with a large amount of traffic, if a problem with the ramp is encountered, then the traffic should be rolled back. This is not an issue here since the direction of traffic would be shifted back to the legacy stack and have data propagated to the new stack. This is done in a similar fashion as ramping forward.

As another example regarding how two databases may become synchronized, a dual-write approach may be implemented. In the dual-write approach, once data is copied from database 234 to new database 240, future write requests from online clients to old services 212 or 214 are processed by those old services and forwarded to new service 216, which is configured to process such client write requests. Also, future write requests from online clients to new service 216 are processed by new service 216, modified according to the APIs supported by one of old services 212 or 214, and forwarded to one of old services 212 or 214. However, the dual-write approach is error prone since, if the second write fails, this will lead to the two databases in question having inconsistent data. This dual-write approach also requires a separate methodology to do a one-time bulk upload of data into the new database 240.

Once the legacy and new databases are synchronized, for future write requests that are directed to new service 216, a second stream processor that is associated with new database 240 propagates writes to legacy database 234. The second stream processor converts data from the new data schema to the old data schema. In this way, online client write requests received by legacy services 212 and 214 are written to a legacy database while online client requests received by new service 216 are written to new database 240. The first stream processor propagates, to new database 240, changes made to data stored in the legacy database while the second stream processor propagates, to a legacy database, changes made to data stored in new database 240.

### Traffic Routing

Once the legacy and new databases are synchronized, not only can client traffic to new service 216 leverage new database 240, client traffic to the legacy service(s) may be routed to new service 216. FIG. 2C illustrates a third stage of migration where online client requests received by legacy service 212 (and, though not shown, legacy 214) may be forwarded to new service 216, in an embodiment.

In an embodiment to enforce traffic routing, legacy services 212 and 214 are modified such that when legacy services 212 and 214 receive an online client request, a call is made to a new API (of new service 216) with the proper parameters and invocation contexts set. New service 216 transforms the response (e.g., as a result of a read request) to the same format as the legacy API, which returns that as the original request's response with all of the proper HTTP statuses and error codes set from the new API. Modified instances of legacy services 212 and 214 may be added one at a time and old instances of legacy services 212 and 214 may be deprecated so that any slowdown in processing online traffic is not noticeable.

In an embodiment, not all client requests received by legacy services 212 and 214 are forwarded to new service 216 once the legacy and new databases are synchronized. Instead, online traffic from legacy services 212 and 214 to new service 216 is ramped incrementally. In an embodiment, whether a client request is forwarded from a legacy service to new service 216 or the client request traverses through the existing legacy code path is controlled within each legacy service so that traffic can be ramped and/or rolled back by owners of new service 216. For example, each record or entity (e.g., company profile) is associated with a flag that indicates (to a legacy service) whether requests associated with those records/entities should be handled by the legacy stack or the new stack (including new service 216 and new database 240). Over time, more and more records/entities are associated with a flag that indicates that those records/entities should be handled by the new stack. As traffic is ramped to the new stack, fewer and fewer online clients of legacy APIs depend on the legacy implementations and data sources, while the behavior of the legacy APIs remains exactly the same. Since QPS is transferred from the legacy database(s) to new database 240, the capacity requirement of new database 240 is known and can mimic the legacy database(s).

Initially, write traffic goes through the old technology stack (including old service 212 and old database 234) and propagates to the new technology stack (including new service 216 and new database 240). The end state is for write traffic to go through the new stack and propagate back to the legacy stack. There are several solutions to transition from the initial state to the end state. One option is to use the flag approach across the two stream processors to enable one but not the other. This could result in processing the same event multiple times in a loop or dropping some events. A second option is to also use the flag approach but pause writes before ramping to ensure that events are fully flushed out before switching the stream processors.

A third option is to create a separate table storing the source of events, i.e., from which stack the event originated, and have the stream processors lookup this table to determine the direction of propagation. This third option requires the most development but results in no downtime, no duplicate processing, and no dropped events. In each of these options, both the legacy and new technical stacks can serve traffic concurrently as traffic migration is ramped. Once fully ramped, data is only propagating from the new database to legacy database, which can be maintained as long as needed for nearline and offline clients to consume.

Once the traffic is fully ramped (i.e., all online traffic directed to one of legacy services 212 or 214 is being forwarded to new service 216), the next step is to have new service 216 (the one hosting the new APIs) host the legacy APIs concurrently alongside legacy services 212 and 214. The implementation of the legacy API on the new service 216 will mostly be the same except that instead of making an over-the-network call to the new API, the new service 216 instead directly executes the implementation of the new API. This eliminates the need for an extra over-the-network call (e.g., from legacy service 212 to new service 216).

After legacy services 212 and 214 and new service 216 host legacy APIs, online client traffic may be load balanced such that online traffic may be directed to new service 216. Load balancing may be implemented by updating front end servers that are communicatively between the online clients and services 212-216 to forward some client requests to new service 216 instead of to legacy services 212 and 214. Such load balancing is seamless for online clients because the behavior of the legacy APIs is the same in both the legacy and new services. Computing nodes hosting the legacy services 212 and 214 may be gradually taken down so that more and more online traffic is directed to new service 216, until all computing nodes of the legacy services are taken down. Once complete, all client traffic goes only through new service 216 (and not legacy services 212 and 214), and the legacy stack can be decommissioned, unless there are offline or nearline clients that rely on data stored in legacy database 234, in which case the portion of the legacy stack that does not include the legacy databases is decommissioned. All of this (traffic routing, ramping, etc.) is done without impacting online clients and needing to coordinate with them.

Errors in business logic and intermittent failures may potentially result in inconsistencies between databases. A record may exist in one database and not the other, or a record may contain different data than its corresponding record in the other database. In an embodiment, the first and second stream processors detect such inconsistencies and resolve them idempotently. Because retries are built into the stream processors, all such inconsistencies are auto-corrected to minimize client impact.

FIG. 2D illustrates a fourth stage of migration where online client requests are all directed to new service 216, in an embodiment. At this point, legacy services 212-214 and their associated components may be decommissioned or taken offline. Also, in order to support offline and nearline clients, intermediate storage 250 and a change capture system 260 are added and made to communicatively couple to new database 240. The processes by which offline and nearline clients are migrated to intermediate storage 250 and change capture system 260, respectively, are described in more detail below.

### Process Overview

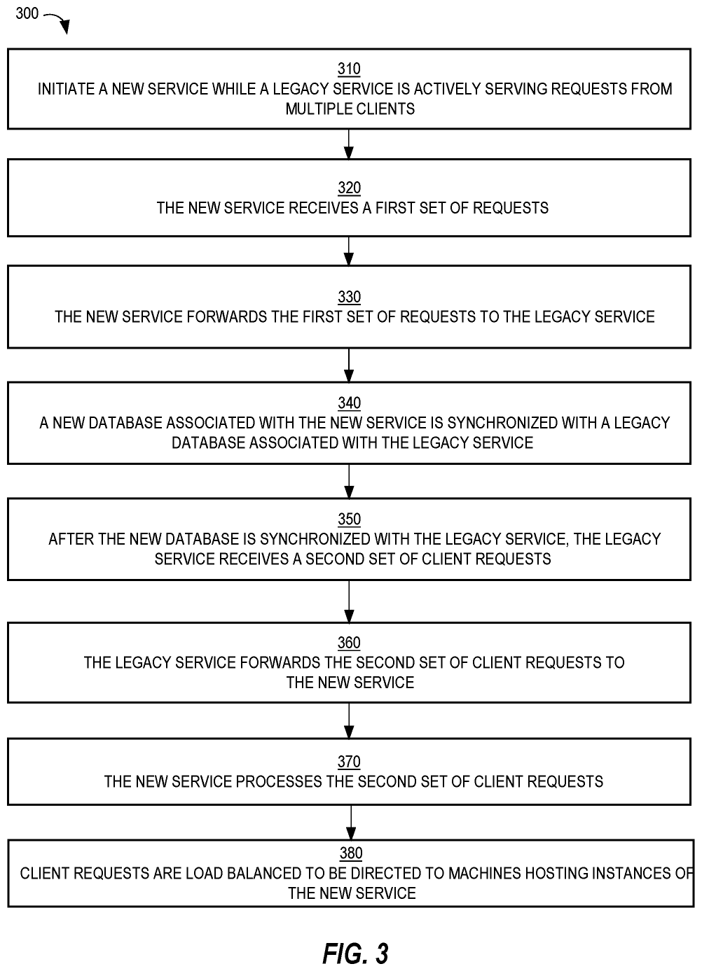

FIG. 3 is a flow diagram that depicts a process 300 for migrating online clients to a new technology stack, in an embodiment.

At block 310, while a legacy service is actively serving requests from multiple clients, a new service is initiated. Initiating a new service may involve installing software code on one or more powered computing machines and causing the installed code to execute on each machine. The legacy service reads data from and writes data to a legacy database in response to the requests. One or more online clients are allowed to send requests to the new service. “Allowing” an online client to send a request to the new service may involve starting an instance of the new service on each of one or more machines and making the one or more machines and instances visible to intermediate routing devices that route requests from clients to services. If a client request specifies a particular service and/or is formatted in a particular way, then an intermediate routing device directs the client request to a machine that hosts the particular service.

At block 320, the new service receives a first set of client requests. The first set of client requests may conform to a first format that is different than a second format to which client requests that are transmitted to the legacy service conform

At block 330, the new service forwards the first set of client requests to the legacy service. Block 330 may involve, for a particular client request, the new service calling an API that is supported by the legacy service but that is not supported by the new service. The legacy service processes the call and returns (e.g., requested) data associated with the call to the new service, which may modify the data according to a data schema and/or format that is expected by the client that initiated the particular client request.

At block 340, a new database is synchronized with the legacy database. The synchronization may have begun prior to the new service receiving the first set of requests. During block 340, the legacy service may be receiving and processing client requests and the new service may be forwarding other client requests to the legacy service.

At block 350, after the new database is synchronized with the legacy database, the legacy service receives a second set of client requests.

At block 360, the legacy service forwards the second set of client requests to the new service.

At block 370, the new service processes the second set of client requests. In the context of a write request, “processing” may involve converting data that is to be written to the new database from one data schema to another. In the context of a read request, “processing” a client request may involve converting data that is read from the new database from one data schema to another and transmitting the converted data to the legacy service, which forwards the converted data to a client that initiated the client request. Alternatively, instead of the new service converting the data to the old data schema, the new service returns (to the legacy service) the data that the new service retrieved from the new database, and the legacy service is modified to convert that data to the old data schema (or the legacy API format).

At block 380, online client requests are load balanced, such that they are directed to machines hosting instances of the new service. Once the legacy stack (including the legacy service) is no longer processing any client requests, the legacy stack may be decommissioned or taken down. For example, machines that were hosting instances of the legacy service may be loaded with code for running instances of the new service.

### Offline Client Migration

In an embodiment, system architecture 200 includes offline clients. (In an alternative embodiment, system architecture 200 does not include offline clients.) An offline client is a client that does not access any of services 212-216. An offline client is one that relies on data that is derived from data that is stored in a database, such as legacy database 234 or new database 240. Having real-time data is not a requirement for offline clients. For example, a delay of 24 hours in up-to-date (or “fresh”) data may be satisfactory.

Derived data may be stored in an intermediate data storage, such as a HDFS (or Hadoop Distributed File System), to which offline clients have access. The data from a database is read and is part of a workflow that involves one or more operations, such as an ETL (extraction, transformation, and loading) operation. The ETL'd data is stored in the intermediate data storage and one or more additional operations (e.g., as indicated by one or more jobs) may be performed thereon. An example of additional operations is using machine learning techniques to train a prediction model based on training data the is based on data stored in legacy database 234.

With potentially hundreds of offline clients, it is time consuming and expensive to migrate each one of them to a new source-of-truth data source. Legacy data sources cannot be decommissioned until all offline clients have migrated. In a time-constrained business world where speed of execution is paramount, offline clients should be able to begin migrations even if the new data source is not yet ready yet and complete the migrations with as little effort as possible.

In an embodiment, derived offline data sources (e.g., HDFS) that have the exact same schemas and data as the current data sources are created. An offline transformation workflow reads (loads) from current data sources (e.g., legacy database 232 and legacy intermediate storage), transforms the read data (e.g., converts the data conforming to one data schema to another data schema), and writes the transformed data to the derived data sources. At this point, client migrations can begin migrating to the new derived data sources, even if the new source-of-truth data source is not ready yet. Since the data schemas are the same as the current data schemas, offline clients only have to modify the path from which they are reading, and the rest of their workflows and business logic remains the same.

When the new source-of-truth data source (e.g., intermediate data storage that is based on the data in new database 240) is actually ready, the offline transformation workflow can then read from new database 240. At this point, every offline client that has migrated to the derived offline data source will immediately be depending on the new source-of-truth instead of the legacy data source. The legacy data source can then be decommissioned.

Once all offline clients have migrated to a derived data source, all future source-of-truth migrations can be done without affecting the offline clients, and backwards incompatible schema evolutions can also be made to the backing data sources.

### Nearline Client Migration

In an embodiment, system architecture 200 includes nearline clients. (In an alternative embodiment, system architecture 200 does not include nearline clients.) Similar to an offline client, a nearline client is a client that does not access any of services 212-216. A nearline client is one that relies on data that is derived from data that is stored in a database, such as legacy database 234 or new database 240. A nearline client has requirements for fresh or up-to-date data. For example, a nearline client maintains a search index for searching organizations. When a change to an organization occurs and the change is made to the organization's profile in a database (or a new organization profile is created), the change should also be reflected in the search index so that users that are submitting queries relating to organizations will receive up-to-date data.

With potentially many nearline clients, it is time consuming and expensive to migrate each one of them to a new source-of-truth data source. Legacy data sources cannot be decommissioned until all nearline clients have migrated. In a time-constrained business world where speed of execution is paramount, nearline clients should be able to begin migrations even if the new data source is not yet ready and complete the migrations with as little effort as possible.

In an embodiment, nearline views of data streams that have the same data schemas and data as streams from current data sources are created. In an example implementation, Samza SQL is used to create a view with the exact same schema as the current data source. Initially, events are consumed from the current data source and then outputted to the view. At this point, client migrations can begin migrating to the new view, even if the new source-of-truth data source is not yet ready. Since the data schemas of the new view are exactly the same as the current data schemas, the nearline clients are only required to modify the path from which they are consuming, and the rest of their business logic remains the same.

When the new source-of-truth data source is actually ready, events can be consumed from the new data source (e.g., the second stream processor) and then outputted to the view instead. A transformation may be performed on data retrieved from the new data source to ensure that the data contained within the view at least conforms to the legacy data model/schema. At this point, every client that has migrated to the view will immediately be depending on the new source-of-truth instead of the legacy data source. The legacy data source can then be decommissioned. The view may contain two versions of the underlying data: one that conforms a new data model/schema and one that conforms to a legacy data model/schema. In this way, both legacy nearline clients and new nearline clients may read from the same view and operate according to their respective data model/schemas.

Once all nearline clients have migrated to (or have started reading from) the view, all future source-of-truth migrations can be done without affecting the nearline clients, and backwards incompatible schema evolutions can also be made to the backing data sources.

### Multi-Datasource Validation

In an embodiment, multi-data source validation is performed. Multi-data source validation involves determining whether data stored in legacy database 234 is the same as data stored in new database 240, even though the data schemas of the respective databases may be different.

In an embodiment, multi-data source validation involves loading data from legacy database 234 (e.g., by taking a snapshot) into first intermediate storage (e.g., HDFS) and loading data from new database 240 into second intermediate storage, which may be the same or different than the first intermediate storage. Such loading may be configured to be performed automatically at regular intervals, such as daily or hourly depending on needs. An offline workflow then reads the loaded data from both sources (i.e., the intermediate storage), transforms the data from one source to the data schema of the other source (e.g., data that originates from legacy database 234 is transformed to be formatted according to the data schema of new database 240), and performs comparisons to validate consistency. A validation involves checking whether a record/row/object exists in both data sources and, if so, whether the records have the same data in both data sources. If an inconsistency is detected, then the records are outputted to a file, which is then read by a particular process (e.g., an MBean) that makes online requests to read from both data sources and performs validations again. This second validation is added because the loading from legacy database 234 and new database 240 may occur at different times, which means changes to a record may be loaded sooner from one data source than the other and be flagged as inconsistent by the offline validation. By eliminating false positives, unnecessary write traffic is avoided in place of computationally inexpensive read calls.

An alternative to the particular process that analyzes inconsistencies detected by the offline workflow is to have the offline workflow push stream processing (e.g., Apache Kafka) events containing the flagged records and implement a (e.g., Kafka) consumer to process those events and validate the records. The benefit with this alternative is that the repair process is fully automated.

Repairs are done based on the following inconsistency scenarios:
If a record is inconsistent between two data sources, then the record with the latest timestamp is used by converting data from that record to the same data format as the other data source and replacing, in the other data source, (a) the record with the earlier timestamp with (b) the converted data.
If a record exists in one data source but not the other, then data from that record is converted to the same format as the other data source and the converted data is inserted into that data source.
If a record exists in one data source but not the other and the record should be deleted, then the record is deleted.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

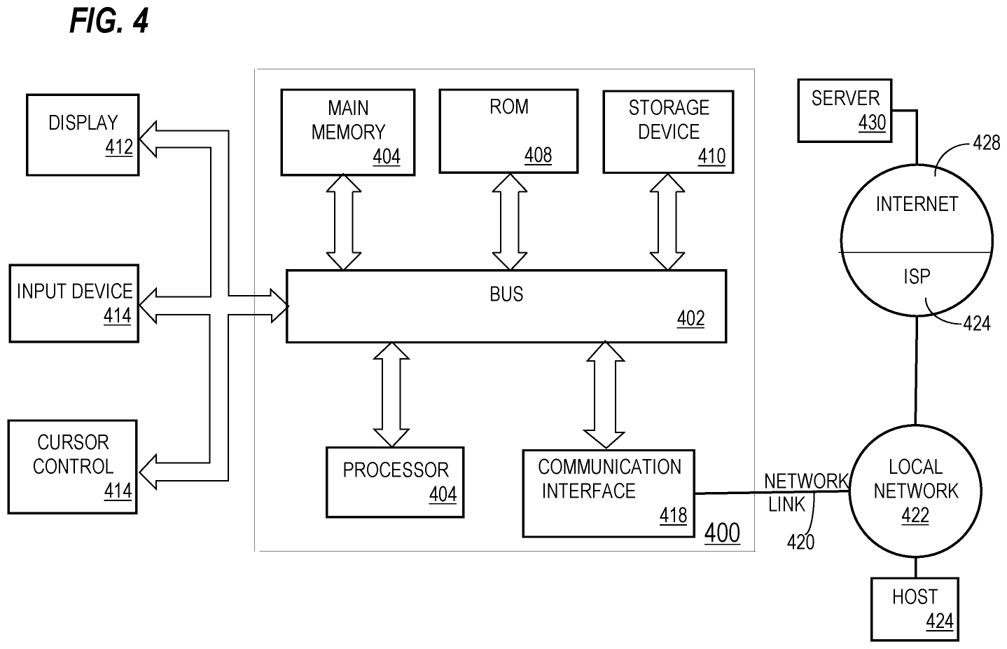

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method for transitioning from a legacy technology stack to a new technology stack, the method comprising:
while hosting a legacy service that is actively serving requests from multiple clients, initiating a new service and allowing one or more clients to send requests to the new service;
wherein the legacy service reads data from and writes data to a legacy database in response to the requests;
forwarding, by the new service, to the legacy service, a first set of client requests that were directed to the new service;
synchronizing a new database with the legacy database;
after synchronizing the new database with the legacy database, forwarding, by the legacy service, to the new service, a second set of client requests;
processing, by the new service, the second set of client requests;
wherein the method is performed by one or more computing devices.

2. The method of claim 1, further comprising:
processing, by the legacy service, a particular client request in the first set of client requests;
wherein processing the particular client request comprises generating a first response that is based on particular data from the legacy database;
sending, by the legacy service, the first response to the new service;
modifying, by the new service, the first response to generate a second response that is formatted differently than the first response.

3. The method of claim 1, wherein synchronizing comprises:
transmitting, by a first stream processor that is associated with the legacy database, to the new database, changes that were made to the legacy database.

4. The method of claim 3, further comprising:
transmitting, by a second stream processor that is associated with the new database and that is different than the first stream processor, to the legacy database, changes that were made to the new database.

5. The method of claim 1, further comprising:
for each client request of a plurality of client requests:
determining whether said each client request is associated with a particular flag;
forwarding said each client request from the legacy service to the new service if it is determined that said each client request is associated with the particular flag.

6. The method of claim 1, further comprising:
processing, by the new service, a particular client request in the second set of client requests;
wherein processing comprises receiving a response from the new database;
generating, by the new service or the legacy service, based on the response, a modified response that is formatted differently than the response.

7. The method of claim 1, further comprising:
hosting, by the new service that hosts a first set of application programming interfaces (APIs), a second set of APIs of the legacy service that is different than the first set of APIs;
receiving, by the new service, client requests associated with one or more APIs in the second set of APIs.

8. The method of claim 7, further comprising:
causing clients requests to be transmitted to the new service;
decommissioning the legacy service.

9. The method of claim 1, further comprising:
loading first data from the legacy database into first intermediate storage;
loading second data from the new database into second intermediate storage;
causing one or more offline clients that read from the first intermediate storage to read from the second intermediate storage.

10. The method of claim 1, further comprising:
transmitting, by a first stream processor that is associated with the legacy database, to a first view, changes that were made to data stored in the legacy database;
transmitting, by a second stream processor that is associated with the new database, to a second view, changes that were made to data stored in the new database;
causing one or more nearline clients that read from the first view to read from the second view.

11. The method of claim 1, wherein the legacy service processes a particular type of data according to a first data schema, wherein the new service processes the particular type of data according to a second data schema that is different than the first data schema.

12. The method of claim 1, wherein the legacy service implements a first application programming interface (API) that is not implemented by the new service and the new service implements a second application programming interface (API) that is not implemented by the legacy service.

13. One or more storage media storing instructions which, when executed by one or more processors, cause:
while hosting a legacy service that is actively serving requests from multiple clients, initiating a new service and allowing one or more clients to send requests to the new service;
wherein the legacy service reads data from and writes data to a legacy database in response to the requests;
forwarding, by the new service, to the legacy service, a first set of client requests that were directed to the new service;
synchronizing a new database with the legacy database;
after synchronizing the new database with the legacy database, forwarding, by the legacy service, to the new service, a second set of client requests;
processing, by the new service, the second set of client requests.

14. The one or more storage media of claim 13, wherein the instructions, when executed by the one or more processors, further cause:
processing, by the legacy service, a particular client request in the first set of client requests;
wherein processing the particular client request comprises generating a first response that is based on particular data from the legacy database;
sending, by the legacy service, the first response to the new service;
modifying, by the new service, the first response to generate a second response that is formatted differently than the first response.

15. The one or more storage media of claim 13, wherein synchronizing comprises:
transmitting, by a first stream processor that is associated with the legacy database, to the new database, changes that were made to the legacy database.

16. The one or more storage media of claim 15, wherein the instructions, when executed by the one or more processors, further cause:
transmitting, by a second stream processor that is associated with the new database and that is different than the first stream processor, to the legacy database, changes that were made to the new database.

17. The one or more storage media of claim 13, wherein the instructions, when executed by the one or more processors, further cause:
for each client request of a plurality of client requests:
determining whether said each client request is associated with a particular flag;
forwarding said each client request from the legacy service to the new service if it is determined that said each client request is associated with the particular flag.

18. The one or more storage media of claim 13, wherein the instructions, when executed by the one or more processors, further cause:
processing, by the new service, a particular client request in the second set of client requests;
wherein processing comprises receiving, by the new service, a response from the new database;
generating, by the new service or the legacy service, based on the response, a modified response that is formatted differently than the response.

19. The one or more storage media of claim 13, wherein the instructions, when executed by the one or more processors, further cause:
hosting, by the new service that hosts a first set of application programming interfaces (APIs), a second set of APIs of the legacy service that is different than the first set of APIs;
receiving, by the new service, client requests associated with one or more APIs in the second set of APIs.

20. The one or more storage media of claim 19, wherein the instructions, when executed by the one or more processors, further cause:
causing clients requests to be transmitted to the new service;
decommissioning the legacy service.
